(19) United States
(12) Patent Application Publication
(10) Pub. No.: US 2017/0235408 A1
(43) Pub. Date: Aug. 17, 2017

(54) TOUCH DISPLAY PANEL AND DRIVING METHOD THEREOF, AND DETECTION METHOD OF SENSING SIGNAL

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Qing YANG, Beijing (CN); Xianjie SHAO, Beijing (CN); Silin FENG, Beijing (CN)

(21) Appl. No.: 15/268,795

(22) Filed: Sep. 19, 2016

(30) Foreign Application Priority Data
Feb. 17, 2016 (CN) 201610090061.0

(51) Int. Cl. G06F 3/041; G06F 3/044

(52) U.S. Cl. CPC G06F 3/0416; G06F 3/044; G06F 3/0412; G06F 2203/04102; G06F 2203/04103

(57) ABSTRACT

A touch display panel and a driving method thereof, and a detection method of sensing signals are provided. A touch region of the touch display panel includes a plurality of touch driving electrodes and a plurality of touch sensing electrodes, and a drive unit is arranged on an edge of the touch region. The drive unit includes a first gate drive circuit to an N-th gate drive circuit coupled sequentially in a cascading manner.

### TECHNICAL FIELD

Embodiments of the present disclosure relate to a touch display panel and a driving method thereof, and a detection method of sensing signals.

### BACKGROUND

Along with continuous development of a display technology, touch screens are applied more and more broadly. According to different working principles, touch screens are generally divided into resistive type touch screens, capacitive type touch screens, infrared type touch screen, etc.

A traditional capacitive touch screen is described as an example; the traditional capacitive touch screen generally comprises touch driving electrodes and touch sensing electrodes. When a drive signal is input to a touch driving electrode, a voltage signal produced by coupling with the touch sensing electrode through a sensing capacitor is correspondingly detected; however, in this process, when a human body touches the capacitive touch screen, an electric field of the human body acts on the sensing capacitor to change the capacitance value of the sensing capacitor, and then a touch position of the human body on the capacitive touch screen can be determined by detecting such change. But all touch driving electrodes in the traditional capacitive touch screen need to be led out to an edge of the touch panel from a touch region of the touch panel, and then led out to outside of the touch panel from the edge of the touch panel and is connected to a control chip. And, the more the touch driving electrodes are lead out, the larger the area of the edge region required by the touch panel is, and thus, the touch device of the traditional capacitive touch screen cannot meet the development trend toward a narrow frame design. Besides, the fact that many touch driving electrodes are lead out causes certain difficulty in binding the touch panel with a flexible circuit panel, and a problem of poor binding easily occurs.

### SUMMARY

An embodiment of the present disclosure provides a touch display panel, comprising: a plurality of touch driving electrodes and a plurality of touch sensing electrodes provided in a touch region of a touch display panel, and a drive unit provided on an edge of the touch display panel and configured to provide drive signals for the touch display panel; the drive unit includes a first gate drive circuit to an N-th gate drive circuit coupled sequentially in a cascading manner, an enable terminal of the first gate drive circuit is connected to a field sync signal line on the edge of the touch display panel, and an output terminal of a (N−1)-th gate drive circuit is connected to an enable terminal of an adjacent N-th gate drive circuit; an input terminal of the first gate drive circuit to an input terminal of the N-th gate drive circuit are connected to a drive signal line provided on the edge of the touch display panel respectively, and an output terminal of the first gate drive circuit to an output terminal of the N-th gate drive circuit are each correspondingly coupled to one of the touch driving electrodes respectively, where N is an integer greater than or equal to 2.

Another embodiment of the present disclosure provides a driving method for a touch display panel, for driving the above-mentioned touch display panel, comprising: providing, by a drive unit, drive signals for a first gate drive circuit to an N-th gate drive circuit from a drive signal line; providing, by the drive unit, an enable signal for the first gate drive circuit through a field sync signal line, to make the first gate drive circuit charge a touch driving electrode correspondingly coupled to the first gate drive circuit; providing, by the first gate drive circuit, an enable signal for an adjacent second gate drive circuit in a case of N being greater than 2, to make the second gate drive circuit charge a touch driving electrode correspondingly coupled to the second gate drive circuit, and so on, till the (N−1)-th gate drive circuit provides an enable signal for the N-th gate drive circuit, to make the N-th gate drive circuit charge a touch driving electrode correspondingly coupled to the N-th gate drive circuit, thereby finishing a driving process of all touch driving electrodes.

Still another embodiment of the present disclosure provides a detection method of sensing signals, for detecting a sensing signal in the above-mentioned touch display panel and in a case of N being greater than 2, comprising:

step 101: providing, by a drive unit, drive signals for a first gate drive circuit to an N-th gate drive circuit from a drive signal line;

step 102: providing, by the drive unit, an enable signal for the first gate drive circuit through a field sync signal line, to make the first gate drive circuit charge a touch driving electrode correspondingly coupled to the first gate drive circuit; judging whether a first voltage signal coupled from the plurality of touch sensing electrodes is changed, and if yes, determining a node position corresponding to the changed first voltage signal; and

step 103: providing, by the first gate drive circuit, an enable signal for an adjacent second gate drive circuit in a case of N being greater than 2, to make the second gate drive circuit charge a touch driving electrode correspondingly coupled to the second gate drive circuit; judging whether a second voltage signal coupled from the plurality of touch sensing electrodes is changed, and determining a node position corresponding to the changed second voltage signal, and so on, till the (N−1)-th gate drive circuit provides an enable signal for the N-th gate drive circuit, to make the N-th gate drive circuit charge a touch driving electrode correspondingly coupled to the N-th gate drive circuit, judging whether a N-th voltage signal coupled from the plurality of touch sensing electrodes is changed, and if yes, determining a node position corresponding to the changed N-th voltage signal, thereby finishing a detection process of all touch driving electrodes.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is an overall structural schematic view of a touch display panel provided by an embodiment of the present disclosure;

FIG. 2 is a structural schematic view of the touch display panel provided by the embodiment of the present disclosure;

FIG. 3 is a drive timing view of the touch display panel provided by the embodiment of the present disclosure; and

FIG. 4 is a schematic view of a drive unit of the touch display panel.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

In order to avoid the problem that the touch device cannot meet the development trend toward a narrow frame design and the problem that binding is poor, a traditional capacitive touch screen is modified in the present disclosure. A driving principle similar to a Gate-on-Array (GOA) technology is adopted, shift register units are introduced to both the edge and the touch region of the capacitive touch screen to make the shift register units on the edge serve as drive circuits to input drive signals to the touch driving electrodes in sequence, and to make the shift register units in the touch region scan the nodes corresponding to sensing electrodes. In this way, only drive signal lines connected to the shift register units on the edge need to be led out from the touch region and then connected to a control chip, the development trend of the touch device toward the narrow frame design is met and binding yield is improved. But in the improved capacitive touch screen, because the shift register units are introduced to the edge and the touch region, the capacitive touch screen has problems in a use process for example that scanning periods are long and reporting rate or scanning rate is disadvantageously affected, and when the touch region in such a capacitive touch screen is overlapped with a display region, thin film transistors in the shift register units in the touch region (which is a visible region) are affected by a light-induced degradation effect, and electrical conductivity is reduced. Therefore, a novel touch screen is urgently needed to solve the above problems.

FIG. 1 is an overall structural schematic view of a touch display panel provided by an embodiment of the present disclosure. As illustrated in the view, the touch display panel 100 comprises a touch region 130 defined by a dotted line box, a drive unit 110 and a touch control circuit (for example a touch chip) 120. The touch display panel is provided with a plurality of touch driving electrodes Tx1-Txn parallel with each other and a plurality of touch sensing electrodes Rx1-Rxn parallel with each other. The touch driving electrodes Tx1-Txn and the touch sensing electrodes Rx1-Rxn intersect with each other and are mutually insulated at the intersecting positions to form touch capacitors. Besides, the touch driving electrodes Tx1-Txn are connected to the drive unit 110 respectively, and the touch sensing electrodes Rx1-Rxn are connected to the touch control circuit 120 respectively. As illustrated in FIG. 1, the touch control circuit 120 for example can be connected to the drive unit 110 from a drive signal line CLK and a field sync signal line CP, thereby providing a drive signal and a field sync signal for the drive unit 110. However, in other embodiments of the present disclosure, the drive signal and the field sync signal can be provided by another independent control circuit, and thus the drive signal line CLK and the field sync signal line CP are electrically connected to the another independent control circuit.

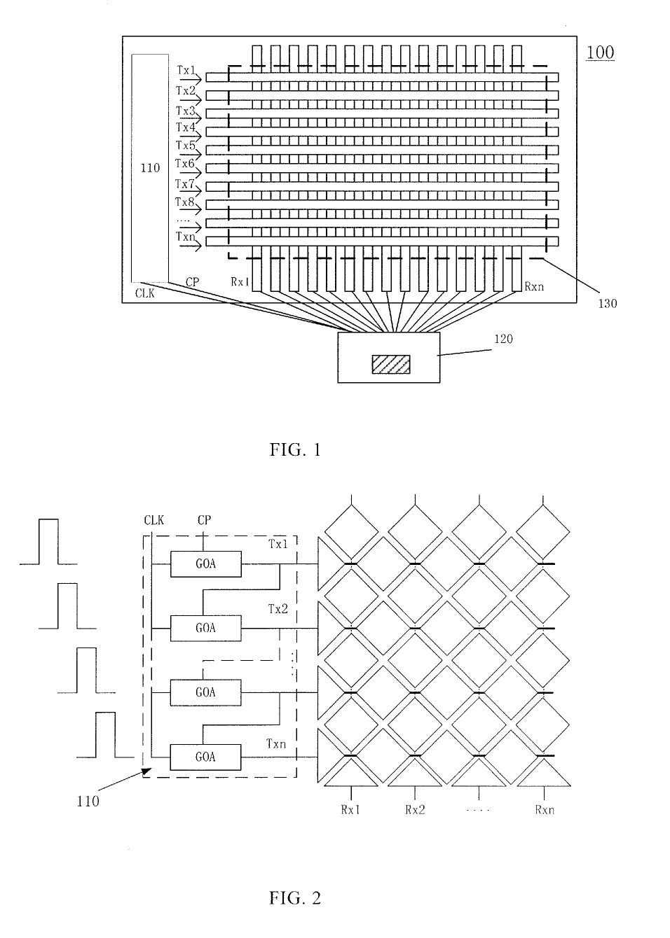

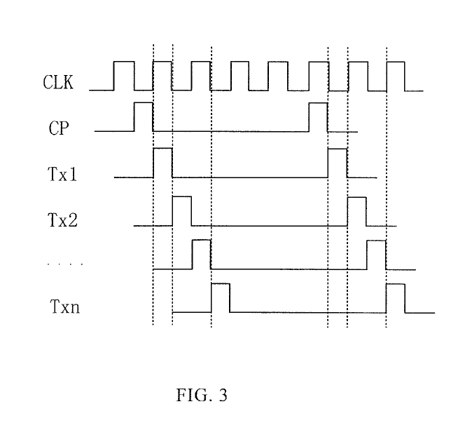

Referring to FIG. 2, an embodiment of the present disclosure provides a touch display panel; a touch region of the touch display panel is provided with a plurality of touch driving electrodes Tx1-Txn parallel with each other and a plurality of touch sensing electrodes Rx1-Rxn parallel with each other, and an edge of the touch display panel is provided with a drive unit 110 for providing drive signals for the touch display panel. As illustrated in the view, each of the touch driving electrodes Tx1-Txn is obtained by connecting a plurality of rhombus electrode blocks along a transverse direction in the view, and each of the touch sensing electrodes Rx1-Rxn is obtained by connecting a plurality of rhombus electrode blocks along a longitudinal direction in the view. The touch driving electrodes Tx1-Txn and the touch sensing electrodes Rx1-Rxn intersect at jointing positions between the adjacent rhombus electrode blocks and are mutually insulated. Obviously, the touch driving electrodes Tx1-Txn and the touch sensing electrodes Rx1-Rxn in the embodiments of the present disclosure are not limited to the specific structure as illustrated in FIG. 2 and can adopt other suitable structures, for example, the touch driving electrodes Tx1-Txn and the touch sensing electrodes Rx1-Rxn are each in an elongated shape or a bar shape, or the touch driving electrodes Tx1-Txn and the touch sensing electrodes Rx1-Rxn are each formed by round electrode blocks connected to each other. The touch driving electrodes Tx1-Txn are coupled to the drive unit 110 respectively. The touch control circuit is not illustrated in FIG. 2, and the touch sensing electrodes Rx1-Rxn are coupled to the touch control circuit respectively.

As illustrated in the view, the drive unit 110 includes: first (1st) to N-th gate drive circuits GOA-1 to GOA-N coupled sequentially in a cascading manner, an enable terminal of the first gate drive circuit GOA-1 is connected to a field sync signal line CP on the edge of the touch display panel, and an output terminal of a (N−1)-th gate drive circuit GOA-n-1 is connected to an enable terminal of an adjacent (next) N-th gate drive circuit GOA-n; an input terminal of the first gate drive circuit to an input terminal of the N-th gate drive circuit are all connected to a drive signal line CLK provided on the edge of the touch display panel respectively, and an output terminal of the first gate drive circuit to an output terminal of the N-th gate drive circuit are correspondingly coupled to the touch driving electrodes Tx1-Txn respectively, where N (and n) is an integer greater than or equal to 2.

When the drive unit drives the drive touch display panel to operate, the drive signal line provides drive signals for the first through N-th gate drive circuits respectively; the field sync signal line provides an enable signal for the first gate drive circuit, such that the first gate drive circuit begins operating and charges a touch driving electrode correspondingly coupled to the first gate drive circuit according to the received drive signal. When the output terminal of the first gate drive circuit outputs a signal, the output signal provides an enable signal for the adjacent (next) second gate drive circuit while charging the touch driving electrode, such that the second gate drive circuit charges a touch driving electrode correspondingly coupled to the second gate drive circuit, and so on, till the (N−1)-th gate drive circuit provides an enable signal for the N-th gate drive circuit, such that the N-th gate drive circuit charges a touch driving electrode correspondingly coupled to the N-th gate drive circuit, thereby finishing the driving process of the touch display panel by the drive unit.

According to the touch panel of the present embodiment, the drive unit providing the drive signals for the touch display panel is arranged on the edge of the touch display panel and only one drive signal line and one field sync signal line needed for driving, thereby greatly improving binding yield; a wiring design (layout) of a flexible circuit panel bound to the touch display panel becomes simpler accordingly, the package of a control circuit for controlling the touch display panel to work is reduced, and the production cost is reduced.

It should be noted that a specific structure of the touch region of the touch display panel can adopt various structures, for example, a double layer ITO (indium tin oxide) structure or a single layer bridging structure, but the embodiment of the present disclosure is not limited thereto. For the double layer ITO structure, the touch driving electrodes Tx1-Txn and the touch sensing electrodes Rx1-Rxn are made from an ITO material and formed on different layers, and are separated from each other by an insulation layer. For the single layer bridging structure, the touch driving electrodes Tx1-Txn and the touch sensing electrodes Rx1-Rxn are formed in the same layer, for example, each of the touch driving electrodes Tx1-Txn is continuous, while each of the touch sensing electrodes Rx1-Rxn is non-continuous but are segmented by the touch driving electrodes Tx1-Txn, but in the positions intersecting with the touch driving electrodes Tx1-Txn, disconnected electrode segments on both sides of the touch driving electrodes Tx1-Txn are connected by a bridging line on a different layer.

The first to the N-th gate driving electrodes provided by above embodiment are various in configuration as long as the corresponding touch driving electrodes can be driven. For example, the first to the N-th gate drive circuits are shift register circuits. Because the technology of the shift register circuits is relatively mature, the shift register circuits are more stable in a working process, thereby better ensuring implementation of the driving process.

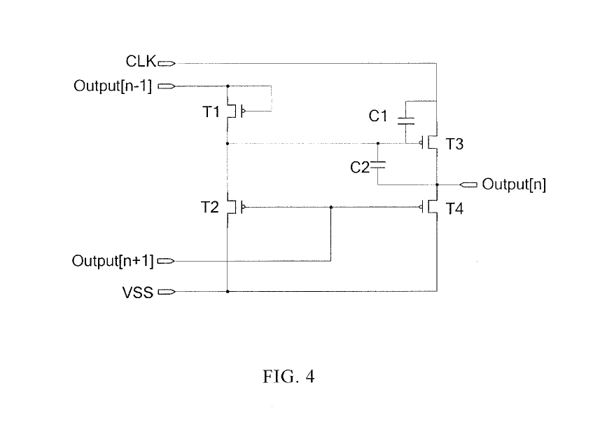

Referring to FIG. 4, a circuit structure of a specific example of the shifting register circuit is provided. The shifting register circuit includes four transistors T1-T4, and each transistor has a gate terminal G, a source terminal S and a drain terminal D. The gate terminal and the source terminal of the transistor T1 are connected together as an enable terminal of the gate drive circuit, the drain terminals of the transistors T3 and T4 are connected together as an output terminal of the gate drive circuit, the source terminal of the transistor T3 is connected to the drive signal line, the source terminal of the transistor T4 is connected to a voltage power source VSS, the source terminal and the gate terminal of the transistor T3 are connected to a first capacitor 3, and the drain terminal and gate terminal of the transistor T3 are connected to a second capacitor C2. The shift register circuit suitable for the embodiment of the present disclosure is not limited to this specific example as illustrated in FIG. 4.

Because the thin film transistor in the gate drive circuit may suffer from a current leakage phenomenon due to a photoelectric effect under light illumination, in order to avoid such current leakage, the drive unit can be disposed under a black matrix on the edge of the touch display panel, such that the drive unit is fully covered and shielded by the black matrix. The position of the black matrix is located in the position of the dotted line box as illustrated in FIG. 2. In this way, the thin film transistors in the gate drive circuits are not irradiated by light, thereby avoiding the current leakage phenomenon caused by the photoelectric effect and bringing a user to have better user experience when the user uses the touch screen.

For example, the touch display panel provided by the above embodiment comprises a display panel and a touch panel that are provided separately, and a touch region of the touch display panel is just the touch region of the touch panel, and specific positions of the display panel and the touch panel mainly comprise two examples as follows.

A first positional relationship is that the display panel and the touch panel are two independent parts, and the touch panel is located above the display panel. The touch screen of the touch display panel adopting such structure is, for example, an add-on touch display screen (e.g., OGS, GFF, On-cell structure). In this add-on touch screen, when the drive unit is introduced to the edge of the display panel, a semiconductor layer is needed to be added on the edge of the touch panel as a conducting layer for the thin film transistors in the gate drive circuits of the drive unit, and the material of the semiconductor layer is preferably α-Si. Because α-Si is a kind of direct bandgap semiconductor, its internal structure contains many “suspension bonds”, that is, electrons that do not form bonds with peripheral silicon atoms, and these free electrons can generate current under action of an electric field without aid of phonons. Therefore, the semiconductor layer made of α-Si can be very thin, and the manufacturing cost is relatively low. Other leads in the gate drive circuits can be formed on the same layer as the electrodes (ITO layer or metal layer) with a conductive property in the touch region according to the specific structure of the touch region, that is, the leads and the electrodes with a conductive property in the touch region can be formed at the same time by a one manufacturing process without any additional manufacturing process.

A second positional relationship is that the touch panel is located in the display panel. The touch screen of the touch display panel adopting such structure is an in-cell touch screen (in-cell structure). Such in-cell touch display screen includes a display panel, and the plurality of touch driving electrodes and the plurality of touch sensing electrodes are provided in the display panel, the drive unit for providing drive signals for the touch driving electrodes and the circuits for driving gate lines of the display panel may be synchronously formed on the display panel for example.

For example, the drive unit for providing driving signals for the touch driving electrodes and the circuit for driving the gate line of the display panel are independently arranged without cross noises. During manufacturing, the thin film transistors constituting the drive unit and the thin film transistors constituting the circuits for driving the gate lines of the display panel can be synchronously made without any extra procedure.

Because a GOA technology can be adopted in the display panel, and the gate drive circuits used in the GOA technology are the same as the gate drive circuits in the embodiment of the present disclosure in driving principle, the gate drive circuits for driving the touch panel and the gate drive circuits for driving the display panel can be integrated into the same drive circuits, that is, the drive unit for driving the touch panel and the drive unit for driving the display panel are integrated into the same drive unit, such that the integrated drive unit can drive both the display panel and the touch panel; thus, the operation of manufacturing the drive circuit corresponding to the touch panel does not need to be added, and therefore, the production costs can be reduced and the effects of the narrow frame design and higher binding yield are achieved.

An embodiment of the present disclosure further provides a driving method for a touch display panel, which is used for driving the touch display panel. The driving method for a touch display panel comprises the following steps/operations:

Step S101: providing, by a drive unit, drive signals for a first gate drive circuit to an N-th gate drive circuit from a drive signal line;

Step S102: providing, by the drive unit, an enable signal for the first gate drive circuit through a field sync signal line, to make the first gate drive circuit charge a touch driving electrode correspondingly coupled to the first gate drive circuit;

Step S103: providing, by the first gate drive circuit, an enable signal for an adjacent second gate drive circuit in a case of N being greater than 2, to make the second gate drive circuit charge a touch driving electrode correspondingly coupled to the second gate drive circuit, and so on, till the (N−1)-th gate drive circuit provides an enable signal for the N-th gate drive circuit, to make the N-th gate drive circuit charge a touch driving electrode correspondingly coupled to the N-th gate drive circuit, thereby finishing a driving process of all touch driving electrodes.

Referring to FIG. 3, the specific driving process of the touch display panel is analyzed in detail by combining a timing view. In an initial state, the enable signal CP provided for the first gate drive circuit by the field sync signal line is at high level, when a first rising edge of the drive signal CLK provided by the drive signal line arrives, the first gate drive circuit outputs a first scanning signal and charges the touch driving electrode Tx1 correspondingly coupled to the first gate drive circuit and the enable signal CP becomes to be at low level; then a second rising edge of the drive signal CLK arrives, and the second gate drive circuit outputs a second scanning signal and charges the touch driving electrode Tx2 correspondingly coupled to the second gate drive circuit, and so on, till the touch driving electrode Txn correspondingly coupled to the N-th gate drive circuit is charged, thereby finishing the driving operation of the whole touch display panel. It is noted that in each rising edge of the drive signal CLK, only one row of the touch driving electrodes are charged correspondingly.

The driving method in the present embodiment is suitable for the touch display panel, the edge of which is provided with the drive unit, only a drive signal and a field sync signal need to be provided for the drive unit in the driving operation, and the binding yield is improved; a wiring design (layout) of a flexible circuit panel bound to the touch display panel becomes simpler accordingly, the package of a control circuit for controlling the touch display panel to work is reduced, and the production costs are reduced.

An embodiment of the present disclosure further provides a detection method of sensing signals, for detecting a sensing signal in the above touch display panel and in a case where N is larger than 2, the detection method of sensing signals comprises the following steps:

Step 101: providing, by a drive unit, drive signals for a first to a N-th gate drive circuits from a drive signal line;

Step 102: providing, by the drive unit, an enable signal for the first gate drive circuit through a field sync signal line, to make the first gate drive circuit charge a touch driving electrode correspondingly coupled to the first gate drive circuit; judging whether a first voltage signal coupled from the plurality of touch sensing electrodes is changed, and if yes, determining a node position corresponding to the changed first voltage signal;

Step 103: providing, by the first gate drive circuit, an enable signal for an adjacent second gate drive circuit in a case of N being greater than 2, to make the second gate drive circuit charge a touch driving electrode correspondingly coupled to the second gate drive circuit; judging whether a second voltage signal coupled from the plurality of touch sensing electrodes is changed, and determining a node position corresponding to the changed second voltage signal, and so on, till the (N−1)-th gate drive circuit provides an enable signal for the N-th gate drive circuit, to make the N-th gate drive circuit charge a touch driving electrode correspondingly coupled to the N-th gate drive circuit, judging whether a N-th voltage signal coupled from the plurality of touch sensing electrodes is changed, and if yes, determining a node position corresponding to the changed N-th voltage signal, thereby finishing a detection process of all touch driving electrodes.

It is noted that when all touch driving electrodes in the touch display panel are subjected to detection of the sensing signals for many times, steps 101-103 can be executed circularly.

In addition, in the above circulation process, when the touch driving electrode Txn correspondingly coupled to the N-th gate drive circuit has been charged, but the detection process has not come to an end yet, a next charging process might have begun, and thus the charging process and the detection process are not synchronized well; for example, in order to avoid such phenomenon, every time after step 103 is executed, a blank time period is inserted, and till the processing on the data required in detection at the present scanning circle is finished, the step 101 in a next cycle is executed.

In practice, every time after the scanning of the touch driving electrodes is finished and before the enable signal for the next frame reaches, a plurality of CLK periods are added to achieve a synchronizing function. The number of the CLK periods that need to be specifically added may be the time for data processing in the touch detection in this circle (i.e., the scanning of the touch electrodes in the present circle), and is specifically related to the processing speed of a Microcontroller Unit (MCU) for processing the touch detection data. This treatment is equivalent to addition of a plurality of virtual touch driving electrodes in the touch panel, after the operation of the step 103 is finished and before the operation of the step 101 is executed again, the plurality of touch driving electrodes are subjected to the detection of the sensing signal.

In the description of the above embodiments, the specific features, structures, materials or characteristics can be combined in a proper way in any one or more embodiments or examples.

The foregoing embodiments merely are exemplary embodiments of the disclosure, and not intended to define the scope of the disclosure, and the scope of the disclosure is determined by the appended claims.

The application claims priority of Chinese Patent Application No. 201610090061.0 filed on Feb. 17, 2016, the disclosure of which is incorporated herein by reference in its entirety as part of the present application.

What is claimed is:

1. A touch display panel, comprising:
a plurality of touch driving electrodes and a plurality of touch sensing electrodes provided in a touch region of a touch display panel, and
a drive unit provided on an edge of the touch display panel and configured to provide drive signals for the touch display panel, wherein
the drive unit includes a first gate drive circuit to an N-th gate drive circuit coupled sequentially in a cascading manner,
an enable terminal of the first gate drive circuit is connected to a field sync signal line on the edge of the touch display panel, and an output terminal of a (N−1)-th gate drive circuit is connected to an enable terminal of an adjacent N-th gate drive circuit; an input terminal of the first gate drive circuit to an input terminal of the N-th gate drive circuit are connected to a drive signal line provided on the edge of the touch display panel respectively, and an output terminal of the first gate drive circuit to an output terminal of the N-th gate drive circuit are each correspondingly coupled to one of the touch driving electrodes respectively, where N is an integer greater than or equal to 2.

2. The touch display panel according to claim 1, wherein the first to the N-th gate drive circuits are shift register circuits.

3. The touch display panel according to claim 1, wherein the drive unit is covered by a black matrix located on the edge of the touch display panel.

4. The touch display panel according to claim 2, wherein the touch display panel includes a display panel and a touch panel that are separately provided, and a touch region of the touch display panel is a touch region of the touch panel; and a semiconductor layer is added to an edge of the touch panel as a conducting layer of thin film transistors in the shift register circuits.

5. The touch display panel according to claim 2, wherein the touch display panel includes a display panel and the plurality of touch driving electrodes and the plurality of touch sensing electrodes are provided in the display panel, and the drive unit and a circuit for driving gate lines of the display panel are formed synchronously.

6. The touch display panel according to claim 2, wherein the drive unit is covered by a black matrix located on the edge of the touch display panel.

7. A driving method for a touch display panel, for driving the touch display panel according to claim 1, comprising:
providing, by a drive unit, drive signals for a first gate drive circuit to an N-th gate drive circuit from a drive signal line;
providing, by the drive unit, an enable signal for the first gate drive circuit through a field sync signal line, to make the first gate drive circuit charge a touch driving electrode correspondingly coupled to the first gate drive circuit;
providing, by the first gate drive circuit, an enable signal for an adjacent second gate drive circuit in a case of N being greater than 2, to make the second gate drive circuit charge a touch driving electrode correspondingly coupled to the second gate drive circuit, and so on, till the (N−1)-th gate drive circuit provides an enable signal for the N-th gate drive circuit, to make the N-th gate drive circuit charge a touch driving electrode correspondingly coupled to the N-th gate drive circuit, thereby finishing a driving process of all touch driving electrodes.

8. A detection method of sensing signals, for detecting a sensing signal in the touch display panel according to claim 1 and in a case of N being greater than 2, comprising:
step 101: providing, by a drive unit, drive signals for a first gate drive circuit to an N-th gate drive circuit from a drive signal line;
step 102: providing, by the drive unit, an enable signal for the first gate drive circuit through a field sync signal line, to make the first gate drive circuit charge a touch driving electrode correspondingly coupled to the first gate drive circuit; judging whether a first voltage signal coupled from the plurality of touch sensing electrodes is changed, and if yes, determining a node position corresponding to the changed first voltage signal; and
step 103: providing, by the first gate drive circuit, an enable signal for an adjacent second gate drive circuit in a case of N being greater than 2, to make the second gate drive circuit charge a touch driving electrode correspondingly coupled to the second gate drive circuit; judging whether a second voltage signal coupled from the plurality of touch sensing electrodes is changed, and determining a node position corresponding to the changed second voltage signal, and so on, till the (N−1)-th gate drive circuit provides an enable signal for the N-th gate drive circuit, to make the N-th gate drive circuit charge a touch driving electrode correspondingly coupled to the N-th gate drive circuit, judging whether a N-th voltage signal coupled from the plurality of touch sensing electrodes is changed, and if yes, determining a node position corresponding to the changed N-th voltage signal, thereby finishing a detection process of all touch driving electrodes.

9. The detection method for a sensing signal according to claim 8, wherein when all touch driving electrodes in the touch display panel are subjected to detection of the sensing signal for many times, steps 101-103 are executed circularly.

10. The detection method for a sensing signal according to claim 9, wherein every time after step 103 is executed, a blank time period is inserted, and till processing on data required in detection in this circle is finished, step 101 in a next cycle is executed.
